(19) United States
(12) Patent Application Publication
(10) Pub. No.: US 2017/0132637 A1
(43) Pub. Date: May 11, 2017

(54) System and method for managing events

(71) Applicant: Veeva Systems Inc., Pleasanton, CA (US)

(72) Inventors: Dan Kallman, Foster City, CA (US); Arno Sosna, Pleasanton, CA (US); David Allen, Pleasanton, CA (US); Jing Zhuang, Danville, CA (US); Neil Greene, Pleasanton, CA (US); Basel Qumsiyeh, San Francisco, CA (US)

(73) Assignee: Veeva Systems Inc., Pleasanton, CA (US)

(21) Appl. No.: 14/936,514

(22) Filed: Nov. 9, 2015

(51) Int. Cl. G06Q 30/00; H04L 29/06

(52) U.S. Cl. CPC G06Q 30/01; H04L 63/102

(57) ABSTRACT

Systems and methods for managing events. A page layout controller may customize user interfaces based on the most current event attributes. With the event management, users can create an event; build an event team; control data access based on event team roles; manage budgets and expenses; and track an audit history of the event.

### BACKGROUND

The subject technology relates to event management in a customer relationship management (“CRM”) system.

In the pharmaceutical sales industry, sales representatives often organize events to communicate product information with healthcare professionals. An event may be any type of gathering, e.g., a seminar, a speaker program, an investigator meeting, or a product launch event. It is desirable to provide a system for sales representatives to plan and execute events, and for their company employers (e.g., pharmaceutical companies) to collect and manage event information.

### SUMMARY

The disclosed subject matter relates to a method for managing events. The method comprises: receiving definitions of a first permission set for a first group of users and a second permission set for a second group of users; receiving access rights of users in each permission set to records in a data storage system, wherein the access rights comprise rights to read, write, edit and delete records; receiving configurations of a first event type and a second event type; receiving definitions of a first flow for the first event type and a second flow for the second event type, wherein the first flow defines progression of status of the first event type, and wherein the status comprise event requested and event approved; receiving definitions of a first event action and a second event action, wherein the first event action changes the first event type from a first status to a second status; and receiving configurations of a first page layout and a second page layout, wherein the first page layout defines data to be displayed thereon, and is determined based on a plurality of event attributes of the first event type comprising the first flow.

### BRIEF DESCRIPTION OF THE DRAWINGS

FIG. 1 illustrates an example high level block diagram of an event management architecture wherein the present invention may be implemented.

FIG. 2 illustrates an example high level block diagram of a computing device.

FIG. 3 illustrates an example high level block diagram of an event management server according to one embodiment of the present invention.

FIG. 4 illustrates an example flowchart of a method for configuring the CRM according to one embodiment of the present invention.

FIG. 5 illustrates an example of event type configuration for speaker programs according to one embodiment of the present invention.

FIG. 6 illustrates an example of completed Event Layout record according to one embodiment of the present invention.

FIG. 7 illustrates an example flowchart of a method for creating an event according to one embodiment of the present invention.

FIG. 8 illustrates an example user interface for creating an event according to one embodiment of the present invention.

FIG. 9 illustrates an example user interface for creating an event according to one embodiment of the present invention.

FIG. 10 illustrates an example flowchart of a method for editing an event according to one embodiment of the present invention.

FIG. 11 illustrates an example user interface for editing an event according to one embodiment of the present invention.

FIGS. 12A and 12B illustrate an example flowchart of a method for approving an event according to one embodiment of the present invention.

FIG. 13 illustrates an example user interface for reviewing an event according to one embodiment of the present invention.

FIG. 14 illustrates an example user interface for editing an event according to one embodiment of the present invention.

FIG. 15 illustrates an example user interface for planning an event according to one embodiment of the present invention.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, well-known structures and components are shown in block diagram form in order to avoid obscuring the concepts of the subject technology.

The subject technology is directed to techniques for creating, planning and managing events. A CRM system may be used to hold and manage event information, sales representative information and healthcare professional information. A page layout controller may customize user interfaces based on event attributes. With the event management, users can create an event; build an event team; control data access based on event team roles; invite attendees, speakers, and employees; manage budgets and expenses; track an audit history of the event; and store a pool of approved speakers and venues.

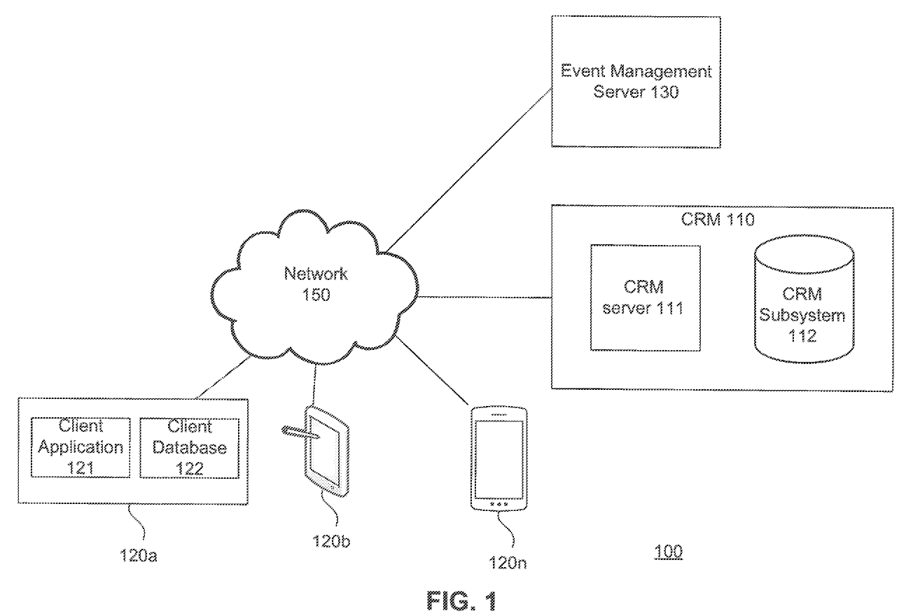

FIG. 1 illustrates an example high level block diagram of an event management architecture 100 wherein the present invention may be implemented. As shown, the architecture 100 may include a CRM system 110, a plurality of user computing devices 120a, 120b, . . . 120n, and an event management server 130, coupled to each other via a network 150. The network 150 may include one or more types of communication networks, e.g., a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

The user computing devices 120a-120n may be any machine or system that is used by a user to access the CRM 110 and the event management server 130 via the network 150, and may be any commercially available computing devices including laptop computers, desktop computers, mobile phones, smart phones, tablet computers, netbooks, and personal digital assistants (PDAs).

A client application 121 may run from a user computing device, e.g., 120a, and communicate with the event management server 130 and the CRM 110 via the network 150. In one embodiment, the client application 121 is a sales tool for helping sales representatives (i.e., users) of pharmaceutical companies to promote products to physicians.

To enable a sales representative to use the client application 121 even when the user computing devices 120a-120n are disconnected and provide seamless transition between online and offline use, a subset of the data in the CRM 110 which may be needed to support the operation of the client application 121 may be stored in a client database 122. Such information may include, e.g., data related to the subset of physicians and/or products in the user's territory. The client database 122 and the CRM 110 may be synchronized regularly according to a preset schedule, in response to a user request, and/or when the user computing device 120a-120n is hack online. Consequently, customers can access accurate, complete and up-to-date data.

The CRM 110 may have a CRM server 111 and a CRM subsystem 112. The CRM server 111 is typically a remote computer system accessible over a remote or local network, such as the network 150. The CRM server 111 could be any commercially available computing devices.

The CRM subsystem 112 may store data that client applications (e.g., 121) in user computing devices 120a-120n may use. In one embodiment, the CRM subsystem 112 may store data that pharmaceutical companies may need when promoting new products, which may include physician professional information (e.g., name, specialty, license information, affiliated health care organization (“HCO”), contact information at the affiliated HCO, prior interaction record, electronic signature fix samples, and medical inquiry submission), product information (e.g., name, category, lot and statistics), sales representative information (e.g., name, territory information, sharing rules and sales reports), and event information. It should be understood that the CRM subsystem 112 may store data for other industries.

In one embodiment, the CRM 110 may be a multi-tenant system where various elements of hardware and software of the CRM 110 may be shared by one or more customers. For instance, a server may simultaneously process requests from a plurality of customers, and a database table may store rows for a plurality of customers. In a multi-tenant system, a user is typically associated with a particular customer. In one example, a user could be a sales representative of one of a number of pharmaceutical companies which are tenants, or customers, of the CRM 110.

In one embodiment, the CRM 110 may be a cloud database which runs on a cloud computing platform. Users can run databases on the cloud independently by using a virtual machine image, or purchasing access to a database service maintained by a cloud database provider.

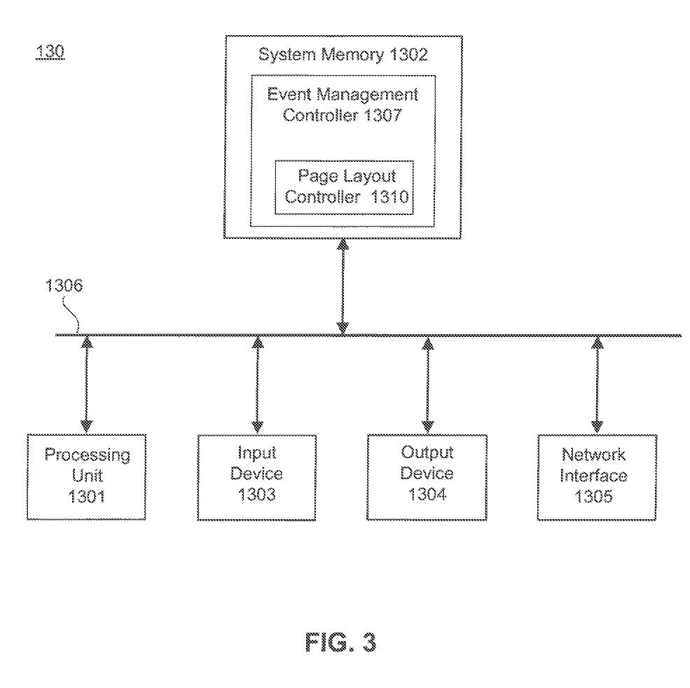

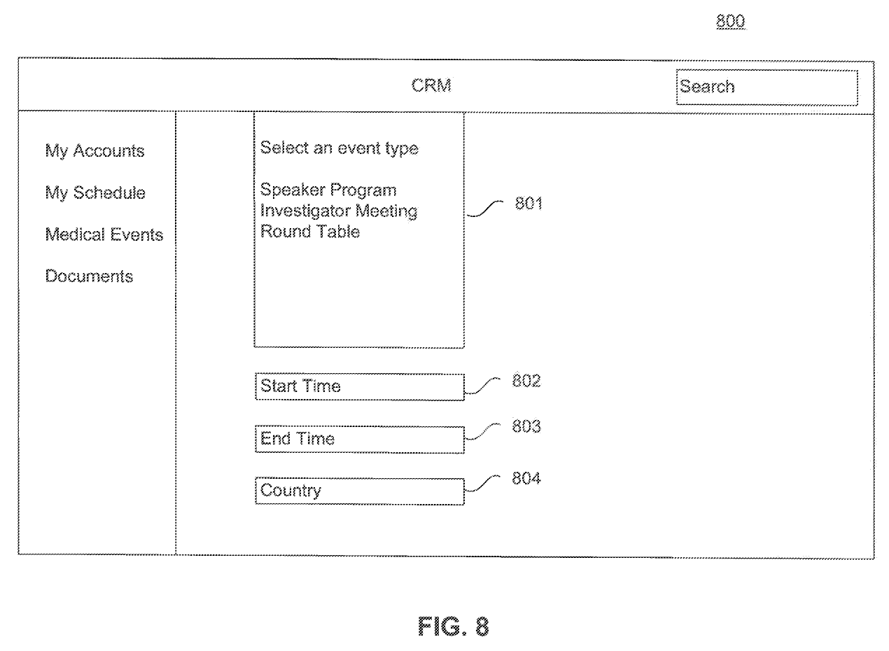

The event management server 130 may include a page layout controller 1310, and may control the process for creating, planning and managing events, as will be described in detail below with reference to FIGS. 3-12B.

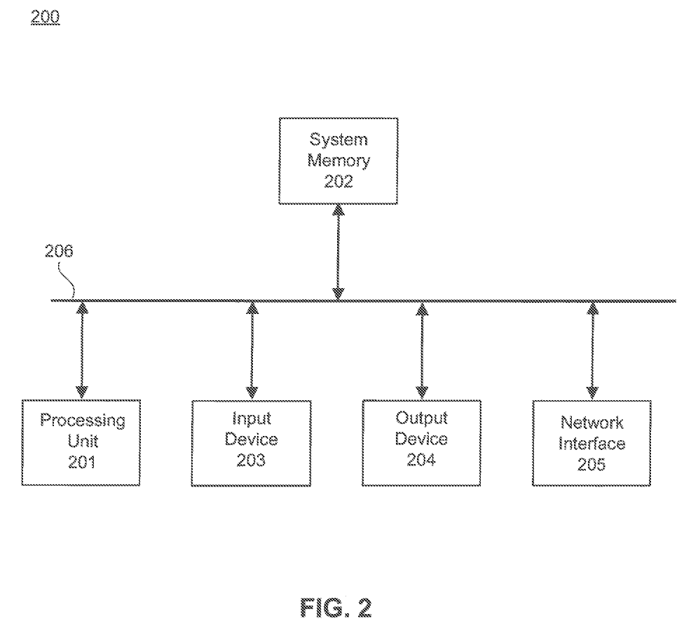

FIG. 2 illustrates an example high level block diagram of a computing device 200 which can be used as the user computing devices 120a-120n, the event management server 130, and/or the CRM server 111 in FIG. 1. The computing device 200 is only one example of a suitable computing environment and is not intended to suggest any limitation as to scope of use or functionality. The computing device 200 may include a processing unit 201, a system memory 202, an input device 203, an output device 204, a network interface 205 and a system bus 206 that couples these components to each other.

The processing unit 201 may be configured to execute computer instructions that are stored in a computer-readable medium, for example, the system memory 202. The processing unit 201 may be a central processing unit (CPU).

The system memory 202 typically includes a variety of computer readable media which may be any available media accessible by the processing unit 201. For instance, the system memory 202 may include computer storage media in the form of volatile and/or nonvolatile memory such as read only memory (ROM) and/or random access memory (RAM). By way of example, hut not limitation, the system memory 202 may store instructions and data, e.g., an operating system, program modules, various application programs, and program data.

A user can enter commands and information to the computing device 200 through the input device 203. The input device 203 may be, e.g., a keyboard, a touchscreen input device, a touch pad, a mouse, a microphone, and/or a pen.

The computing device 200 may provide its output via the output device 204 which may be e.g., a monitor or other type of display device, a speaker, or a printer.

The computing device 200, through the network interface 205, may operate in a networked or distributed environment using logical connections to one or more other computing devices, which may be a personal computer, a server, a router, a network PC, a peer device, a smart phone, or any other media consumption or transmission device, and may include any or all of the elements described above. The logical connections may include a network (e.g., the network 150) and/or buses. The network interface 205 may be configured to allow the computing device 200 to transmit and receive data in a network, for example, the network 150. The network interface 205 may include one or more network interface cards (NICs).

FIG. 3 illustrates an example high level block diagram of the event management server 130. The event management server 130 may be implemented by the computing device 200, and may have a processing unit 1301, a system memory 1302, an input device 1303, an output device 1304, and a network interface 1305, coupled to each other via a system bus 1306. The system memory 1302 may store an event management controller 1307, which may include a page layout controller 1310. The client application (e.g., 121) process may be active on one or more user computing devices 120a-120n, and the corresponding server process, i.e., the event management controller 1307, may be active on the event management server 130. The client application process and the corresponding server process may communicate with each other over the network 150, thus providing distributed functionality and allowing multiple client applications to take advantage of the information-gathering capabilities of the CRM 110 and the event management server 130.

In a CRM system, what a user sees is called page layout. A page layout shows which fields are available, if they are required, if they are editable, etc. A unique feature of events is that they have a workflow. They start out as being requested, then are approved by an approver, then other related information (e.g., attendees) may be added in the event planning phase, and finally they are closed out. Thus, the pieces of information that are available and editable may change as the event workflow goes forward. In addition, the pieces of information that are available and editable may depend on event types. Further, there are business rules in place, such as the user can not change expense estimate after an event is closed out, or can't invite a speaker after the event is in place. To make the event management more efficient, the page layout controller 1310 of the present invention determines page layouts based on a number of event attributes (e.g., the event type, event country, event start time, event status, event team role, and user event management profile), and provides dynamic page layouts which change with the type and workflow of the event. Thus, the page layouts can be flexible and adapt to the needs of the user looking at it.

Different types of events may have different page layouts and workflows. Examples of event types are seminars, speaker programs during which one healthcare provider (“HCP”) speaks to a group of HCPs about a product and its correct usage, investigator meetings for training HCPs on how to conduct clinical trials, or product launch events.

Country is important because users may use a single CRM environment to operate in many countries, e.g., the U.S. and Canada. Since each country may have its own rules, including country into the event attributes makes it possible to follow the specific rules for a particular type of event in each country.

Compliance requirements, especially in the pharmaceutical industry, may change from time to time. By using the event start time as one of the event attributes for determining which page layout a user will get, users may build new configurations in advance, instead of asking an admin to flip the configurations when the new requirements become effective. If a user plans an event which starts after the new requirements are effective, the new configuration will be automatically used. The user may build the rule as, e.g., beginning with the new sales cycle, the new fiscal year, or the sales meeting, the new configuration should be used.

The event status may include requested, pending approval, rejected, approved, and close out. Actions available to the users may be different when the event is at different status. The event status may drive what a user can see on a page.

Each event can have a list of event team members, and any user involved in the planning and execution of an event can be added to the event team. Each user on the event team is assigned an event team role, e.g., requester, approver, vendor or cohost. That role can determine the page layouts and actions available to a particular user. For example, if the user's event team role is not approver, he may be able to see the event information, but can not approve or reject the event

Individual event management profile may include user detail and user preference. User detail may include a user's name, ID, job title, and contact information. User preference may include, e.g., countries he can create events in.

It should be appreciated that the event attributes may include other information.

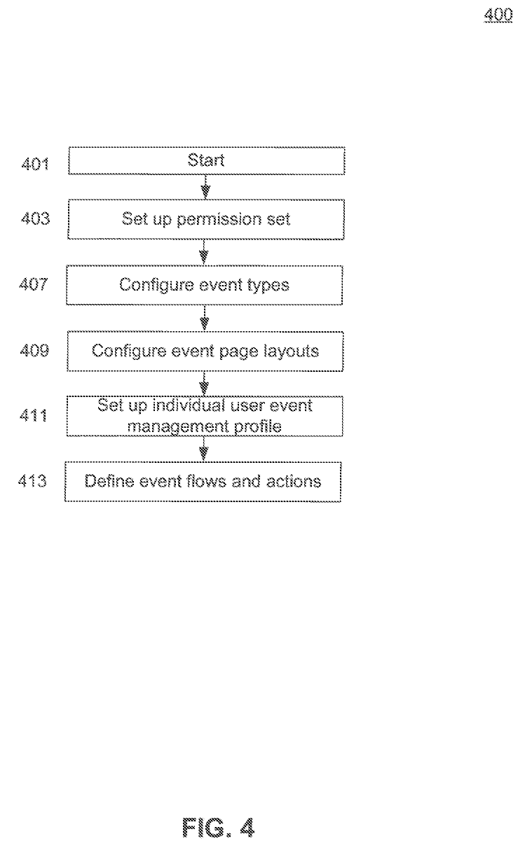

FIG. 4 illustrates an example flowchart of a method for configuring the CRM 110, and more specifically data fields in the CRM 110, according to one embodiment of the present invention. The configuration may be done by an administrator for as customer. The process may start at 401.

At 403, permission sets may be set up. In one implementation, a permission set for sales representatives, a permission set for managers and a permission set for administrators may be set up as follows:
1. EM_REP_USER_VOD
2. EM_MANAGER_USER_VOD
3. EM_DATA_ADMIN_VOD

Permission set profiles may also be set up to grant access to objects, records, pages, tabs and individual fields to each permission set. Table 1 shows an example for granting rights to create (“c”), read (“r”), edit (“e”) and delete (“d”) various types of objects to the three permission sets set up above:

TABLE 1

| Object | Rep | Manager | Admin |
|---|---|---|---|
| EM_Event_vod | cred | cred | cred |
| EM_Event_Attendee_vod | cred | cred | cred |
| EM_Event_Team_Member_vod | cred | cred | cred |
| EM_Vendor_vod | r | cred | cred |
| EM_Venue_vod | r | cred | cred |
| EM_Event_Session_vod | cred | cred | cred |
| EM_Event_Speaker_vod | cred | cred | cred |
| EM_Budget_vod | r | cred | cred |
| EM_Expense_Estimate_vod | cred | cred | cred |
| Expense_Type_vod | r | r | cred |
| Country_vod | r | r | cred |
| EM_Event_Configuration_vod | r | r | cred |
| EM_Event_Rule_vod | r | r | cred |
| EM_Event_Layout_vod | r | r | cred |
| EM_Event_Action_vod | r | r | cred |
| EM_Event_History_vod | r | r | cred |

At 407, event types may be configured to define the types of events that can be processed by the event management controller 1307 for the customer. Examples of event types are seminars, speaker programs, investigator meetings, and product launch events. In one implementation, record types on the EM_Event_vod object may define the various types of events that can be processed by the event management controller 1307.

To configure a new event type, a user may create a record type and enter a description. To define when and where this event type is used, a user may create a new Event_Configuration_vod record containing the event type and time period, and then add the countries using this event type configuration for this time period. The Event Configuration record may be used to group other configurations for this event type as well. In one example, configurations included within the Event Configuration record may include:
1. The effective date for the event configuration (Event Configuration object);
2. The countries using this configuration (Event Configuration Country object);
3. The page layouts in use (Event Layout object);
4. The event flows in use (Event Action Object); and
5. Rules for selecting speakers or external experts to participate in the event (Event Rule object).

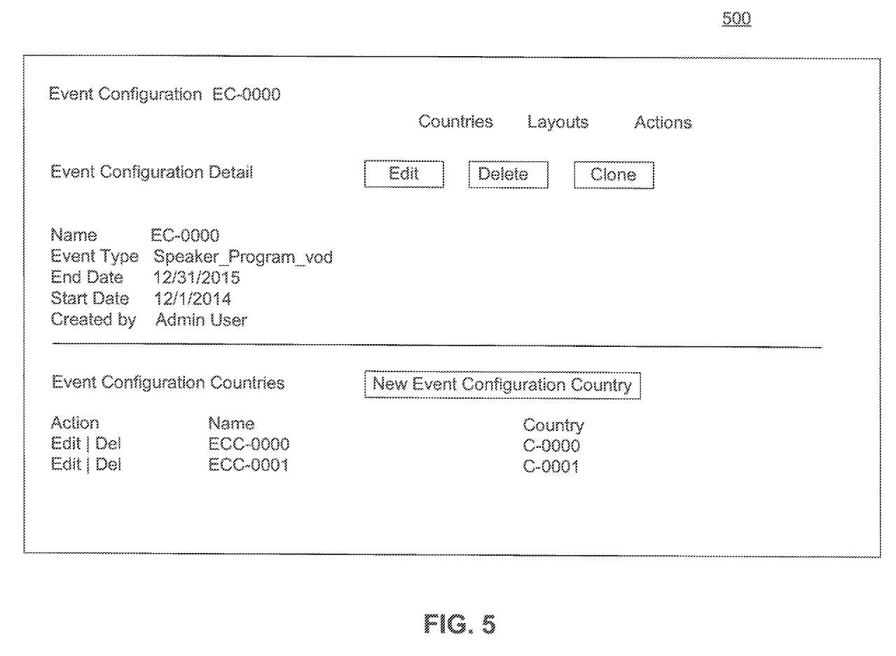

Flows of event types (e.g. request, approve, reject and close out) may be configured by time period. If the configurations are similar for multiple countries, the Event Configuration record may include a list of countries that use this set of configurations, so that the same event type may be used across regions. FIG. 5 shows an example of event type configuration for speaker programs from Dec. 1, 2014 to Dec. 31, 2015 in US and Canada. Any events of the type speaker program occurring in that year in one of the countries may follow the configurations specified. If the variables differ considerably from country to country, a different Event Configuration set may be used for each country.

At 409, event page layouts may be configured to define what data is displayed on a screen to an end user. The page layout controller 1310 may determine which page layout to use based on a set of inputs, so as to provide dynamic user interfaces that display different information depending on several event attributes. These event attributes may be selected from, e.g., the event type, event country, event start time, event status, event team role, and user event management profile.

The page layout controller 1310 may allow granular control over what fields are available and editable on a given page, event actions available, as well as the related lists and the ability to create related records. Permissions can change for specific users based on any event attributes. For example, a default page layout can be set for one sales representative that is not involved with the event, and another page layout can be given to the sales representative that is hosting the event.

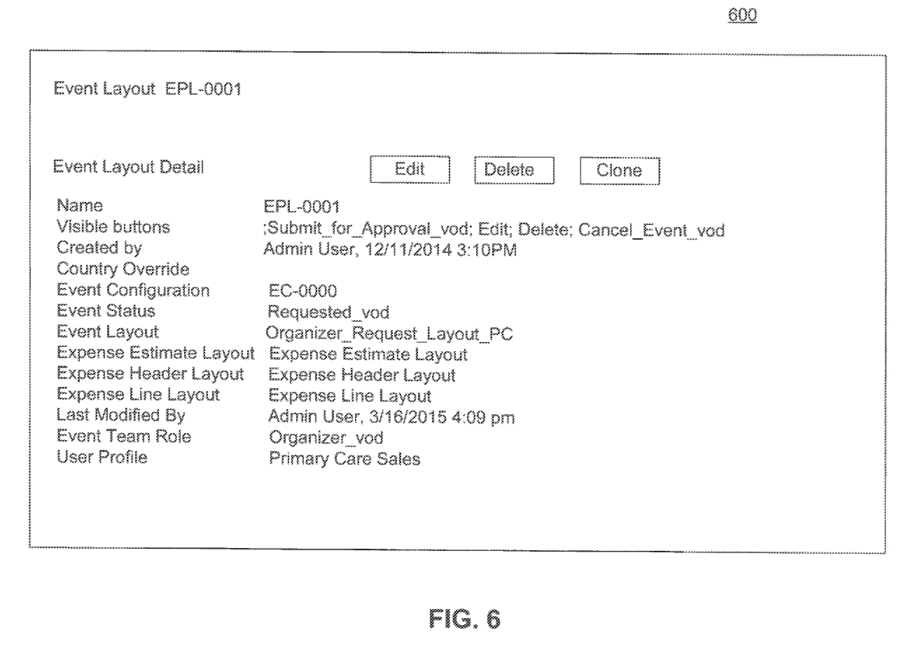

Configuration for the page layouts may be defined in the EM_Event_Layout_vod object. Records in this object are associated with an Event Configuration set, so rules apply within the context of an event type and a time period. Fields included in the Event Layout object may include, e.g., Event Configuration, Event Status, User Profile, Event Team Role, Event Layout, Expense Estimate, Visible Buttons, and Country Override. An example of completed Event Layout record is shown in FIG. 6.

At 411, individual user event management profile may be set up. In one implementation, the individual user event management profile may indicate which country the user can create events in.

At 413, event flows and actions may be defined. Event flows refer to the progression of status for an event and define what lifecycle flows each event type follows. A sample event flow may include: Request, Pending Approval, Approved, Executed, and Closed.

Event flows do not have to be linear. A user may define that if an event is rescheduled after it is approved, it must revert to the Pending Approval status.

Event flows work in conjunction with the page layout controller 1310 and configuration of event types. Each status in the event flow may be used to configure a different page layout that controls what data is visible and editable to someone interacting with the Event record.

Event actions are used to change the status of an event. When the status changes a new page layout displays. An Event Action record may contain a button name, a starting status, and a final status. When a button is clicked on (e.g. Submit for Approval), the event action determines which status the event should move to. Event actions may also support country overrides and a ranking hierarchy.

Since the page layout controller 1310 allows definition of which buttons are visible on an event, event actions allow for granular event flows for different use cases. For example, a user may configure a Submit for Approval button that is available to a sales representative to change an event from status “Requested” to status “Pending Approval”, and another button Compliance Review for a manager to change the status from “Pending Approval” to “Awaiting Compliance Review”.

Event actions may be created within an Event Configuration set, and are applied for a specific event type, country, and time frame combination. Fields in the Event Action object may include:
1. Event Configuration;
2. Button Name (name of the button that initiates the action);
3. Starting Status (the starting event status for which the Event Action is valid);
4. Ending Status (the resulting status from clicking on the button defined in the Event Action);
5. Allowed Comments indicating that the user is allowed to enter comments when the Event Action is launched; and
6. Country Override used to configure a specific page layout that only applied to a single country.

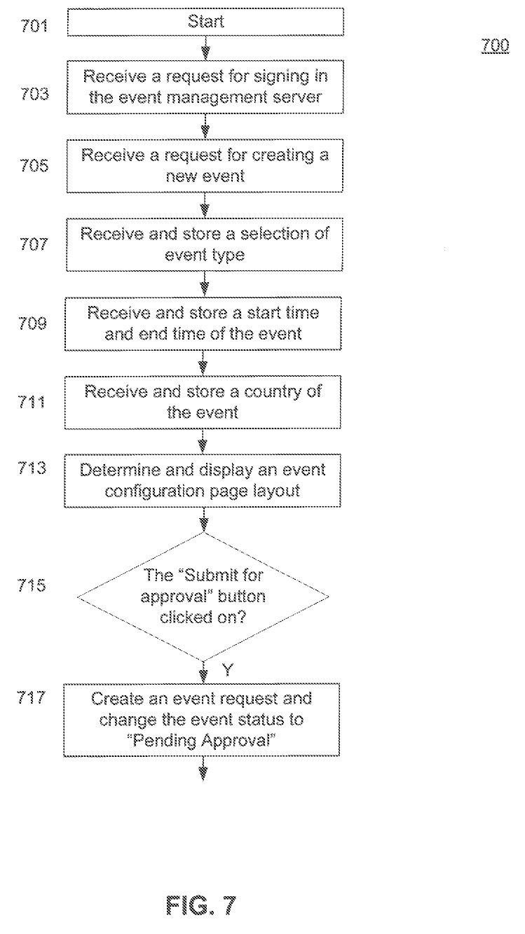

FIG. 7 illustrates an example flowchart of a method for creating an event according to one embodiment of the present invention. The process may start at 701.

At 703, a first user may connect to the network 150, sign in the CRM 110 and the event management server 130. The first user may be a sales representative and is a requester for an event.

At 705, the requester may start the process for creating a new event. In one implementation, the requester may click on a “New Event” button on a user interface.

At 707, a user interface 800 may be displayed for the requester to select an event type and receive a use selection (e.g., speaker program). As shown, the user interface 800 may display a list of the event types in a pull-down menu 801. The user selection may then be stored in the CRM 110.

At 709, a start time and end time of the event may be received on a user interface (e.g., windows 802 and 803 on the user interface 800) and stored in the CRM 110.

At 711, a country for the event may be received on a user interface (e.g., a window 804 on the user interface 800) and stored in the CRM 110. When the requester is authorized to create events in only one country, that country may be used as the default.

At 713, when a valid event type, start time, end time and country are set, an event configuration page layout 900 may be determined by the page layout controller 1310 and displayed. The event attributes used to determine the page layout may include:
1. Event Type, which is selected by the requester at 707;
2. Event Start Time, which is entered by the requester at 709;
3. Event Country, which is either delimited or selected by the requester at 711;
4. Event Status, which may be determined by the default value of the Status vod field on the EM_Event_vod Object;
5. Requester's Event Team Role, which may be determined by the default value of the Role_vod picklist on the EM_Event_Team_Member_vod object; and
6. User's Profile from the CRM 110

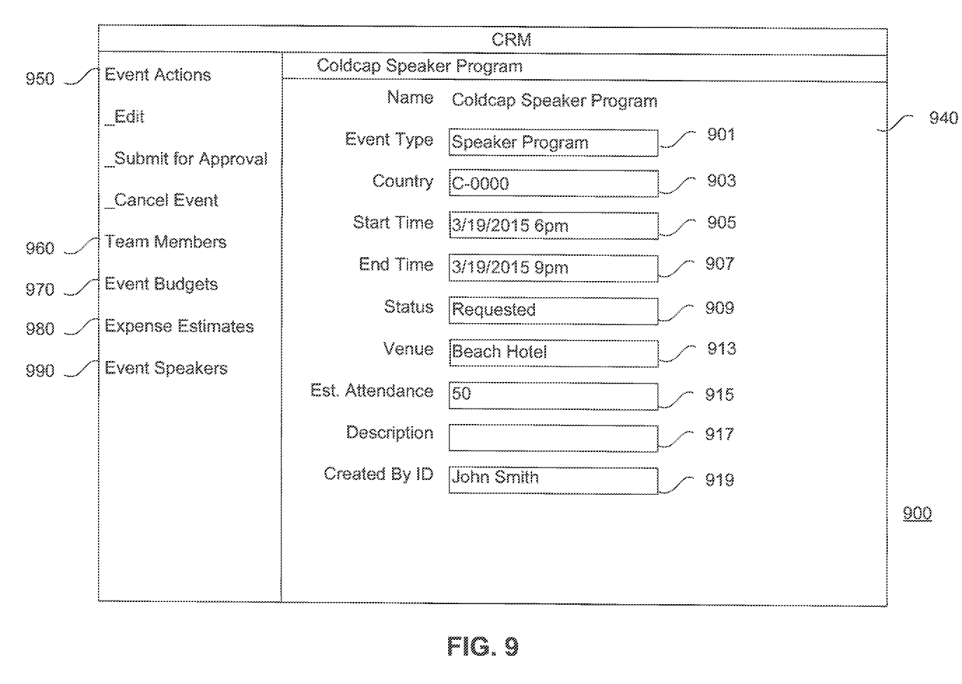

As shown in FIG. 9, the event configuration page layout 900 may have an event information area 940 for displaying the event information, e.g., the Event Type in a window 901, the Event Country in a window 903, the Event Start Time in a window 905, the Event End Time in a window 907, the Event Status in a window 909, the Venue in a window 913, the Estimated Attendance in a window 915, the Description in a window 917, and a Create By ID in a window 919. In one implementation, windows 901-909 and 919 may be automatically filled by the page layout controller 1310 with the available event attributes. The event configuration page layout 900 may also have a time window which may be automatically filled in with the current date and time. The requester may fill in windows 913-917.

The event configuration page layout 900 may have a Team Members button 960, an Event Budgets button 970, an Expense Estimates button 960, and an Event Speakers button 990. When the requester clicks on one of the buttons, a user interface aver corresponding event information may be displayed for the requester to view or edit. For example, if the user clicks on the Team Members button 960, an event team member page may be displayed. His event team role may be defaulted as “Requester”, and he may add other team members, e.g., an approver.

The event configuration page layout 900 may display event actions currently available to the requester under the Event Actions button 950, e.g., Edit, Submit for Approval, and Cancel Event. The event actions may be determined by the page layout controller 1310 based on the event attributes.

The requester may then fill in data on the event configuration page layout 900. At 715, it may be determined if the requester clicks on the Submit for Approval button.

If yes, at 717, an event request may be created based on the event information on the event configuration page layout 900, saved in the CRM 110, and the event status may be changed from Requested to Pending Approval.

A notice may be sent to an approver informing him that an event request is waiting for his approval. In one implementation, the requester may input the approver information manually. In one implementation, a default approver may be provided on the event team member page based on the event team role information, and the requester may select another approver when necessary.

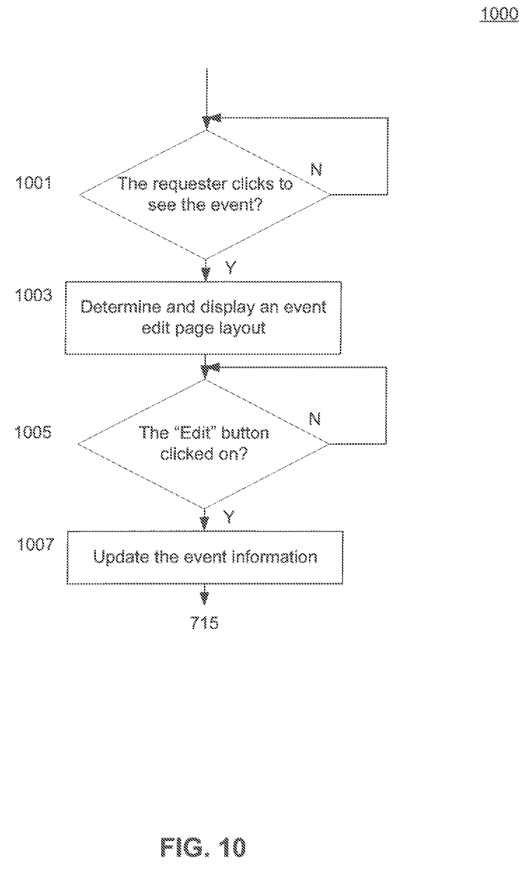

FIG. 10 illustrates an example flowchart of a method for editing an event request according to one embodiment of the present invention.

At 1001, when the event is pending approval, it may be determined if the requester, or another authorized team member, clicks to see the event.

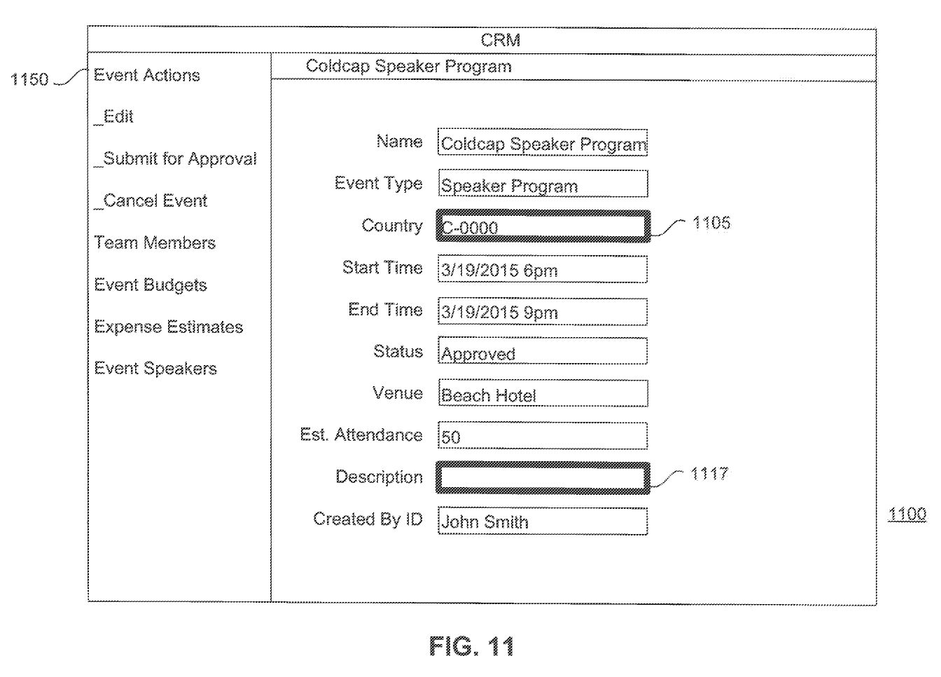

If yes, at 1003, an event edit page layout 1100 may be determined according to the most current event attributes, e.g., the requester's event team role, the event status, and/or the current time. As shown in FIG. 11, the event edit page layout 1100 may have an Event Actions button 1150, and some editable fields. The editable fields may depend on the event attributes and may be marked as editable. In one implementation, the editable fields may include description of the event in a window 1117. In one implementation, the start date of the event in a window 1105 on the page layout 1100 may be moved forward. Fields that are not marked as editable on the event edit page layout 1100 are read-only.

At 1005, it may be determined if the Edit button is clicked on.

If yes, the newly input information may be saved to the CRM 110 to update the event information at 1007, and the process may proceed to 715 in FIG. 7.

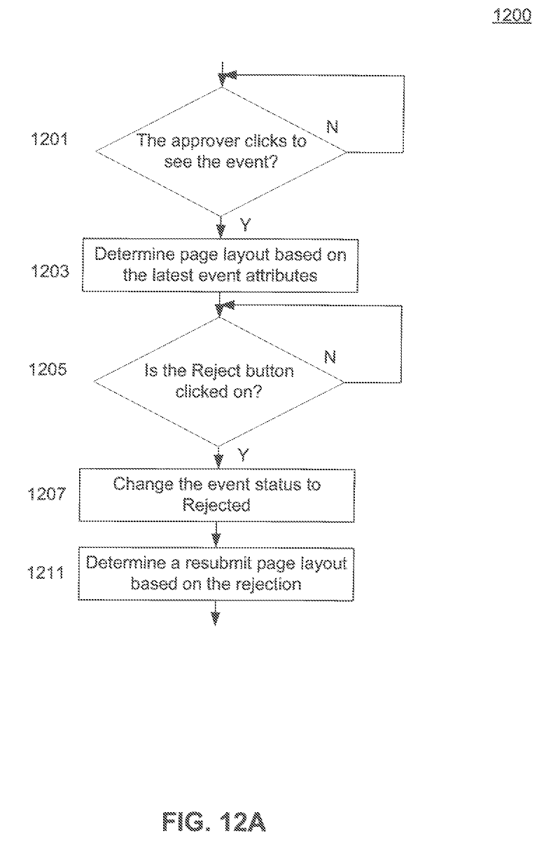

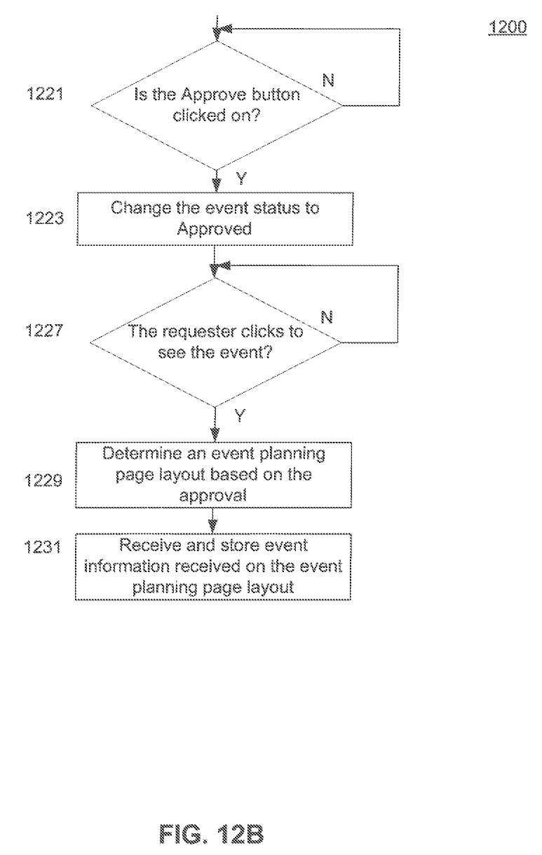

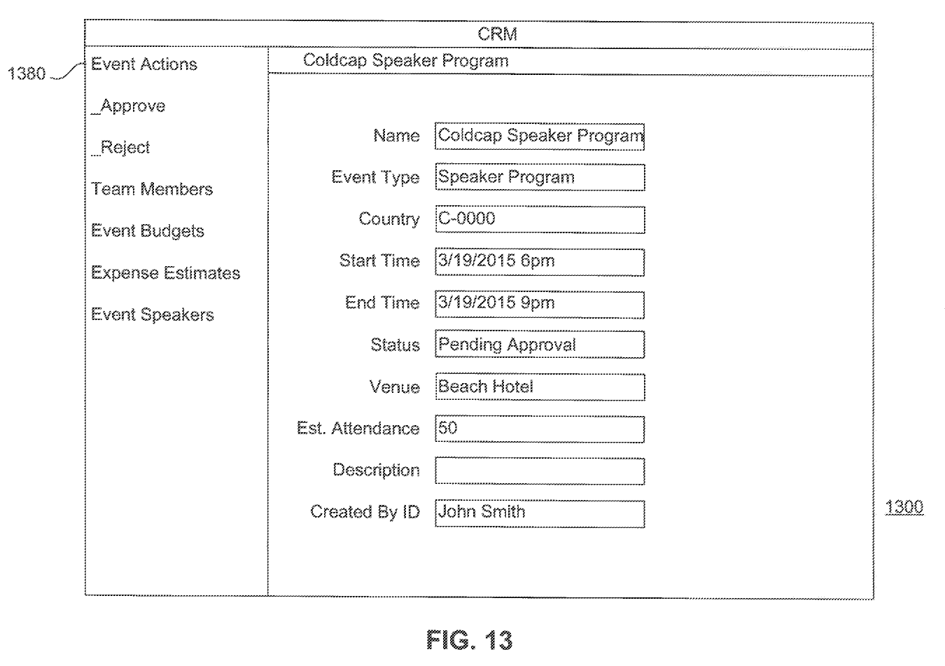

FIGS. 12A and 12B illustrate an example flowchart of a method for approving an event according to one embodiment of the present invention.

At 1201, it may be determined if the approver clicks to see the event.

If yes, at 1203, an approver page layout 1300 may be determined based on the most current event attributes, e.g., by the page layout controller 1310. The most current event attributes may include the approver's event team role and the event status Pending Approval. In addition to the event information, the approver page layout 1300 may display Event Actions 1380 which may include an Approve button and a Reject button, so that the approver may approve or reject the event after reviewing event information.

At 1205, it may be determined if the Reject button is clicked on.

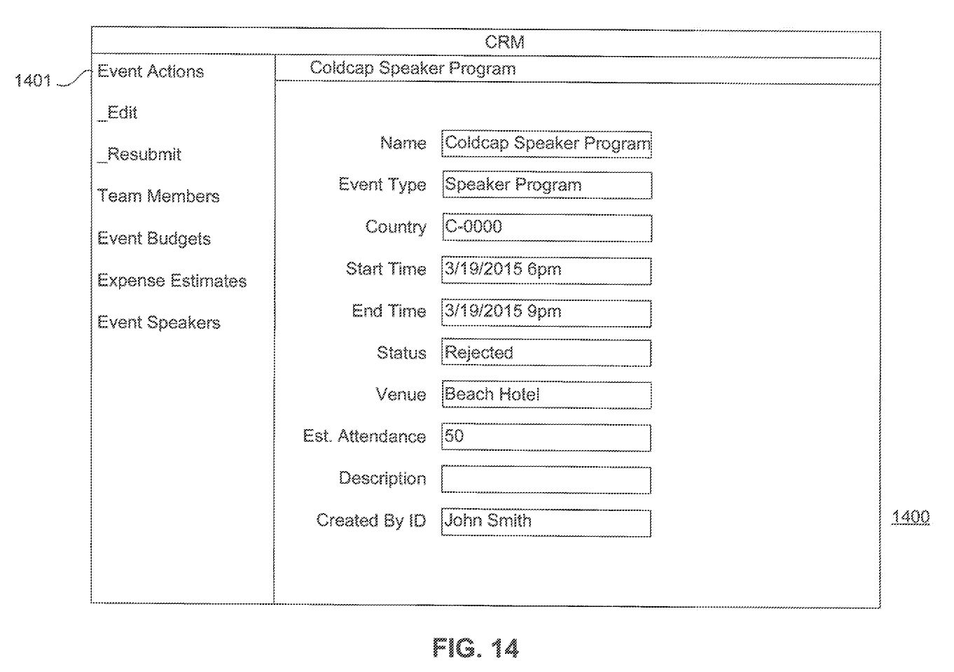

If yes, the event status may be changed to Rejected and saved to the CRM 110 at 1207. Users on the event team may get a new layout with new actions available to them, as will he discussed with reference to FIG. 14.

A notice may be sent to inform the requester that the event has been rejected.

If the requester clicks to see the event, a resubmit page layout 1400 may be determined based on the most current event attributes at 1211, including the new event status Rejected and the requester's event team role. In addition to the event information saved before, the resubmit page layout 1400 may have actions available to the requester, e.g., Edit and Resubmit. If the requester edits the event information and resubmits the event request, the process may then return to 717.

At 1221, it may be determined if the Approve button is clicked on.

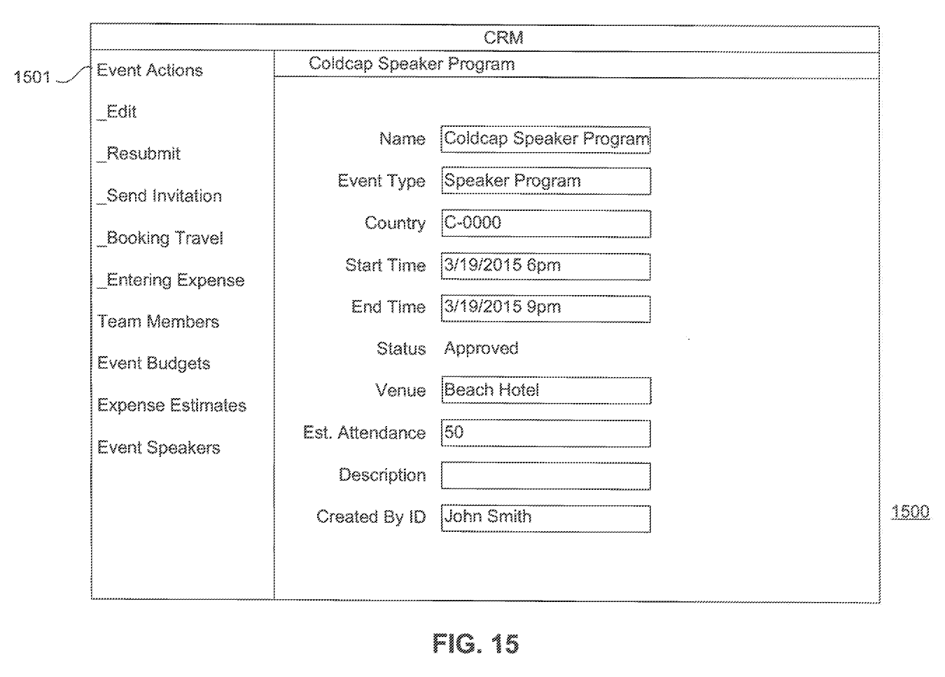

If yes, the event status may be changed to Approved at 1223. Users on the event team may get a new page layout with new actions available to them, as will be discussed with reference to FIG. 15.

A notice may be sent to inform the requester that the event has been approved.

At 1227, it may be determined if the requester clicks to see the event.

If yes, at 1229, the page layout controller 1310 may determine an event planning page layout 1500 based on the latest event attributes, including the new status Approved. The event planning page layout 1500 may have new actions available to the requester and other team members, e.g., sending out invitations, booking travel for speakers and attendees, and entering expenses.

At 1231, information received on the event planning page layout 1500 may be saved to the CRM 110 to update the event information so that users on the event team can access the latest event information.

The requester may close out the event after it is finished.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “software” is meant to include firmware residing in read-only memory or applications stored in magnetic storage, which can be read into memory for processing by a processor. Also, in some implementations, multiple software technologies can he implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “sonic” refers to one or more.

What is claimed is:

1. A computer-implemented method for managing an event, the method comprising:
receiving definitions of a first permission set for a first group of users and a second permission set for a second group of users;
receiving access rights of users in each permission set to records in a data storage system, wherein the access rights comprise rights to read, write, edit and delete records;
receiving configurations of a first event type and a second event type;
receiving definitions of a first flow for the first event type and a second flow for the second event type, wherein the first flow defines progression of status of the first event type, and wherein the status comprise event requested and event approved;
receiving definitions of a first event action and a second event action, wherein the first event action changes the first event type from a first status to a second status; and
receiving configurations of a first page layout and a second page layout, wherein the first page layout defines data to be displayed thereon, and is determined based on a plurality of event attributes of the first event type comprising the first flow.

2. The method of claim 1, wherein the plurality of attributes further comprise page layouts in use.

3. The method of claim 1, wherein the plurality of attributes further comprise an event country.

4. The method of claim 1, wherein the plurality of attributes further comprise an event start date.

5. The method of claim 1, wherein the plurality of attributes farther comprise an event status.

6. The method of claim 1, wherein the plurality of attributes further comprise a user profile.

7. The method of claim 1, wherein the plurality of attributes further comprise an event team role.

8. The method of claim 1, further comprising:
receiving a request for creating a first event;
receiving a first set of attributes of the first event which arc selected from the group consisting of its event type, start time, and country; and
determining a first page layout of the first event based on the first set of attributes,

9. The method of claim 8, further comprising: adding the first set of attributes to corresponding windows on the first page layout of the first event and displaying the first page layout of the first event.

10. The method of claim 8, further comprising: determining that the first event's status is “event requested” and adding it to the first page layout of the first event.

11. The method of claim 8, further comprising: determining a requester's event team role.

12. The method of claim 8, further comprising: determining a first available event action and displaying it on the first page layout of the first event.

13. The method of claim 10, further comprising: changing the first event's status from “event requested” to “pending approval” when a request for approval is received.

14. The method of claim 13, further comprising: storing the first event together with a second set of attributes to the CRM which comprise the “pending approval” status.

15. The method of claim 13, further comprising: in response to a first request to view the first event, determining a second page layout of the first event based on a third set of attributes of the first event which comprise the pending for approval status and a requester event team role, wherein event actions on the second page layout of the first event comprise edit and resubmit for approval.

16. The method of claim 15, wherein the second page layout of the first event displays the third set of event attributes, with editable event attributes marked.

17. The method of claim 15, further comprising: in response to a second request to view the first event, determining a third page layout based on a fourth set of attributes of the first event which comprise the pending for approval status and an approver team role, wherein event actions on the third page layout comprise approving the first event.

18. The method of claim 17, further comprising: changing status of the first event from pending approval to approved in response to an input on the third page layout.

19. The method of claim 18, further comprising: in response to a third request to view the first event, determining a fourth page layout based on a fifth set of attributes of the first event which comprise the approved status and a requester team role, wherein event actions on the fourth page layout comprise sending invitations.

20. A system for managing events, the system comprising an event management controller for:
receiving definitions of a first permission set for a first group of users and a second permission set for a second group of users;
receiving access rights of users in each permission set to records in a data storage system, wherein the access rights comprise rights to read, write, edit and delete records;
receiving configurations of a first event type and a second event type;
receiving definitions of a first flow for the first event type and a second flow for the second event type, wherein the first flow defines progression of status of the first event type, and wherein the status comprise event requested and event approved;
receiving definitions of a first event action and a second event action, wherein the first event action changes the first event type from a first status to a second status; and
receiving configurations of a first page layout and a second page layout, wherein the first page layout defines data to be displayed thereon, and is determined based on a plurality of event attributes of the first event type comprising the first flow.
